(19) United States
(12) Patent Application Publication
(10) Pub. No.: US 2003/0217249 A1
(43) Pub. Date: Nov. 20, 2003

(54) Method and apparatus for virtual register renaming to implement an out-of-order processor

(75) Inventors: Matthew A. Postiff, Chelsea, MI (US); Trevor Mudge, Ann Arbor, MI (US); David Greene, Ann Arbor, MI (US); Steven Raasch, Ann Arbor, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: The Regents of the University of Michigan

(21) Appl. No.: 10/151,605

(22) Filed: May 20, 2002

(51) Int. Cl. G06F 9/30

(52) U.S. Cl. 712/217

(57) ABSTRACT

A computing device including a logical register file having a specified number of logical registers, each logical register storing an architected operand, and a physical register file having a specified number of physical registers, each physical register storing either a speculative operand or a architected operand. A plurality of virtual register numbers is provided that is greater than the number of logical registers plus physical registers. Each virtual register number is assigned to provide a direct index into the physical register file, with additional bits to store other information. A processor processes an instruction by using virtual numbers to directly index the physical register file to obtain any necessary input operand, or to determine that the operand is available only from the logical register file. Accordingly, the physical register file contains some speculative operands and some architected operands while the logical file only contains architected operands.

### FIELD OF THE INVENTION

The present invention relates generally to register renaming in an out of order processor, and more particularly, the present invention relates to register renaming logical registers through a plurality of virtual register numbers to physical registers in order to efficiently implement out of order processing in a superscalar processor.

### BACKGROUND

Register renaming is an important component of modem computer microarchitectures. It allows write-after-read and write-after-write dependencies to be eliminated from the instruction stream, increasing the opportunity to execute multiple instructions at one time. Register renaming assigns a unique identifier to each architected register written by a non-speculative instruction; later instructions that need the value in that register refer to it through the previously assigned identifier. The identifier uniquely identifies what is typically called a physical register because it identifies a physical location inside the processor where the value is stored for a particular architected register.

Register renaming is also integrally related to how the processor performs speculative execution. That is, in order to run faster, a processor guesses which instructions will likely need to be executed next. It assigns physical registers to the operands of these speculative instructions just as for non-speculative instructions. This implies that there must be enough physical registers to house both the architected values and the speculative values.

Register renaming can be used in systems that have a large or small number of architected registers. Large architected register files are advantageous because they allow compiler optimizations to reduce memory and computation operations, thus freeing up the instruction and data caches and memories for more important operations. Techniques such as register windowing and simultaneous multi-threading require a large logical register file as well. A small architected register file may be a design requirement, however, in order to meet backward compatibility requirements. In either case, register renaming can be used to build an out-of-order execution microprocessor.

In the conventional art, the design decision of how many physical registers to have is often coupled very tightly to the number of architected registers in the instruction set architecture. For example, if there are a large number of architected registers, then there often must also be a yet larger number of physical registers. This is problematic because a very large physical register file cannot be implemented to run at a fast clock rate. The computer engineer is hindered by this coupling constraint.

Furthermore, in the conventional art, there have been a number of proposals that attempt to circumvent this constraint, at least for large physical register files. Such proposals have included physically splitting the register file or providing a cache of the most frequently used registers and having a large backing store for the full logical set of registers. The primary observation that these renaming proposals rely on is that register values have temporal and spatial locality. This is the same principle that makes memory caches work. Unfortunately, these techniques only treat the problems that arise from the requirement to implement a large number of physical registers. They do not address the root of the problem, that is, the vital connection between the number of architected registers and the number of physical registers.

With this background, the inventors hereof have recognized the desirability of decoupling the architected registers from the physical registers and providing a way to implement a physical register file of any size regardless of the size of the logical register file.

### SUMMARY

To address the aforementioned problems in the conventional art, the present invention provides a new way to perform register renaming in an out-of-order processor. This new way provides a computing device that includes a logical register file having a specified logical register that stores an architected operand and a physical register file having a specified physical register that stores either a speculative or architected operand. A plurality of virtual register numbers is provided that is greater than or equal to the number of logical registers plus physical registers. A processor executes an instruction based on the architected operand or the speculative operand and uses the virtual numbers to map the logical register file onto the physical register file.

In another aspect, the present invention provides a method for executing an instruction by a processor. Here, a logical register file having at least one specified logical register for storing an architected operand is provided. A physical register file having at least one specified physical register for storing a speculative operand is also provided. A plurality of virtual register numbers is also provided. One virtual register number is a specified virtual register number. The number of virtual register numbers is greater than or equal to the number of logical registers plus physical registers. A register alias table associates a logical register number for the specified logical register with the specified virtual register number. The architected operand is renamed based on the specified virtual register number. The renaming occurs in such a way that a first set of bits of the specified virtual register number directly indexes into the physical register file. This generally consists of the low ordered bits. A second set of bits in the specified virtual register number is used for instruction sequencing and dependency tracking. This generally consists of the high ordered bits, distinct from the low ordered bits. A third set of bits of the specified virtual register number is compared with a virtual register number broadcasted from a producer instruction in order to determine that the producer operand is available for consumption. This generally consists of all the bits in the virtual register number. Some time later, the first set of bits is used to access a physical register in the physical register file. A fourth set of bits (a subset of the second set of bits) of the specified virtual register number is then compared with the corresponding forth set of bits of the virtual register operand in the physical register file to determine whether the producer instruction is a correct producer instruction or an incorrect producer instruction. If the producer instruction is correct, the instruction is executed based on the operand found in the physical register. If not, the instruction is executed based on the architected operand from the architected register file. The output data is then stored at a destination physical register.

An advantageous feature of the present invention is that it allows the physical register file to be split from the logical register file. If the logical register file is very large, then a smaller physical register file can be implemented. This smaller physical register file acts as a cache of the values in the logical register file. Another advantageous feature is that the physical register file is directly indexed from bits in the virtual register number.

Other objects, features, and advantages of the present invention will become more readily apparent from a better understanding of the preferred embodiments described below with reference to the following drawings.

### BRIEF DESCRIPTION OF THE DRAWINGS

The present invention will now be described, by way of example, with reference to the accompanying drawings, in which:

FIG. 1 is a schematic diagram illustrating a Logical Register File, Physical Register File and register renaming as applied to an instruction in a pipeline according to the present invention;

FIG. 2 is a flow chart depicting the execution of an instruction according to the present invention;

FIG. 3 is a flow chart describing the assignment of destination virtual and physical registers for instruction execution according to the present invention; and

FIG. 4 is a schematic view depicting the execution of an instruction according to the present invention.

### DETAILED DESCRIPTION OF THE PRESENT INVENTION

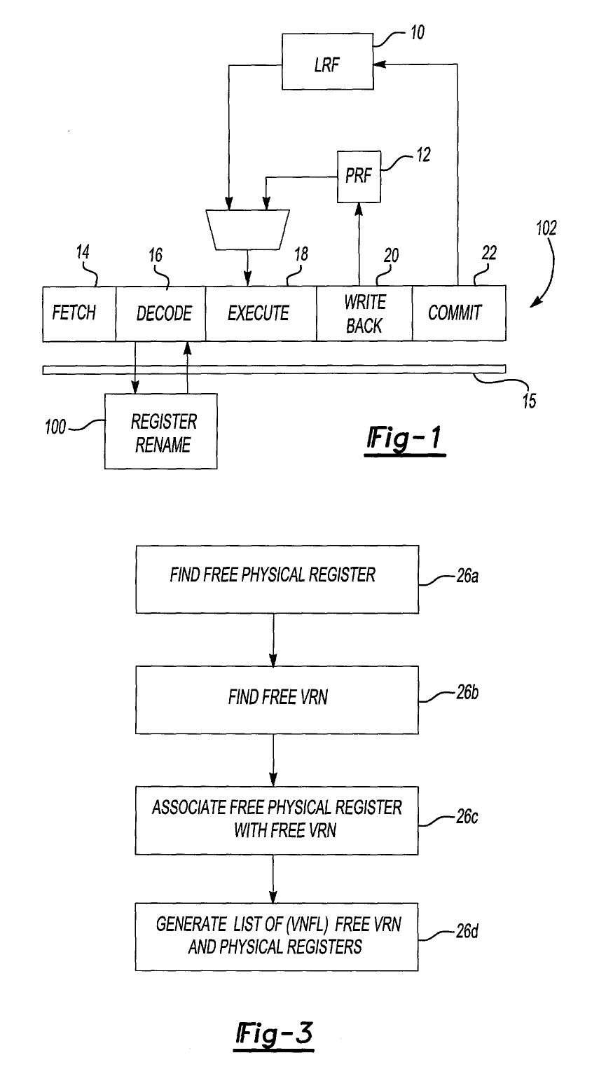

Referring now to FIG. 1, a general overview of the execution of an instruction according to the present invention is provided. Here, a Physical Register File PRF 10 and a Logical Register File LRF 12 are shown in conjunction with an instruction (not pictured) in a pipeline 102 of a processor 15. The instruction is processed by first being fetched in block 14, decoded in block 16, and executed in block 18. Register renaming 100 begins with the decoding step in block 16, as will be discussed in greater detail hereinafter.

After execution, the instruction is then written back to the physical register in block 20. This value is retained in PRF 10 until a new value overwrites it. As the rename storage, PRF 10 contains speculative results destined for the logical register file 12 and some non-speculative results that have already been copied into logical register file 12.

Some time after the instruction is written to PRF 10, the instruction is committed to the architected state in block 22. The instruction is committed to the logical register file LRF 12, which contains the precise architected state at all times. As such, the instruction results in PRF 10 cannot be committed until it is known to be on the correct path of execution and to have had no exceptional conditions preventing its completion.

Instruction values are committed from the final stage in the pipeline at block 22 to avoid having to read the value from the PRF 10 at commit 22. That is, completed instructions copy their value to both the PRF 10 and to an instruction ordering buffer in commit 22. This is also why there is no direct path in FIG. 1 from PRF 10 to LRF 12. Alternatively, read ports can be added to PRF 10 to allow committed values from block 22 to be read from PRF 10 and sent to the LRF 12. Although committed to the architected state, the written value is also retained in PRF 10 after its producing instruction is committed to the architected state in block 22. This is true until it is overwritten.

LRF 12 and PRF 10 of the present invention preferably utilize a split register file approach. Here, the architected state is maintained in the LRF 12 and is kept separate from the speculative state contained in the PRF 10. As such, each separate set of registers has its own register file and is updated as appropriate. As the implementation of the LRF 12 is decoupled from the implementation of the PRF 10, the designer is allowed the most freedom to optimize each individually. In the present invention, LRF 12 can be larger than the PRF 10 and thus provide a natural backing-store to allow the PRF 10 to cache the registers of LRF 12 (as will be assumed during the remainder of this example discussion). LRF12 need not, however, be larger than PRF 10.

The LRF 12 architecture includes the number and configuration of registers supported in the instruction set. The PRF 10 architecture includes the number and configuration of registers in order to have a balanced processor design. LRF 12 file is preferably as large as desired by the software that runs on the machine. LRF 12 also has as many ports as can be sustained within a desired cycle time.

The architecture of PRF 10, on the other hand, is related to implementation technology, design complexity, and desired machine instruction capacity, parameters which are ideally decided long after the instruction set has been fixed. PRF 10 is preferably matched to the characteristics of the processor design in order for the design to be balanced, instead of being matched to the instruction set architecture, as is LRF 12. PRF 10 preferably has as many registers and ports as required in order to have a balanced execution engine.

The number of physical registers (NPR) in PRF 10, however, as stated above, may be less than the number of logical registers (NLR) in LRF 12 (denoted by NPR<=NLR). To facilitate the explanation of the renaming scheme of the present invention, we do assume NPR<=NLR for the remainder of the discussion. In this way, the present invention can be used to implement the architected file in LRF 12, which can be large and somewhat slower while the smaller physical file in PRF 10 can have many ports and still supply operands to the function units quickly.

Integral to the design of the register caching mechanism is that the number of in-flight instructions<=number of physical registers NPR. This ensures that each instruction has a unique slot in PRF 10 for its result. No two uncommitted instructions can have the same physical index. In other words, the number of instructions in flight cannot exceed the machine's capacity. This avoids potential deadlock or conflict conditions in similar proposals, which render them practically unimplementable.

In addition to the LRF 12 and the PRF 10 as described above, a set of virtual registers are provided called the virtual register numbers or VRNs. The virtual registers are not actually registers in the sense that there is no storage associated with them. They are simply addresses that keep track of instruction dependency information. The logical registers of LRF 12 are mapped to the physical registers or PRF 10 through this third (larger) set of VRNs. They are numbers that track data dependences and the location of data in PRF 10 or LRF 12.

The VRNs help avoid a register-release deadlock, allow PRF 10 to be directly indexed instead of associatively indexed, and allow PRF 10 cache to maintain the values after they are committed to the LRF 12. The number of virtual registers (NVR) must be greater than the number of logical registers NLR plus the number of physical registers NPR, such that NVR>NLR+NPR. The virtual registers are assigned such that the low bits of the virtual register number index directly into the PRF 10 and the remaining high bits are used as a check tag as will be explained in greater detail below. A VRN is allocated and released using a merged register renaming approach known to those skilled in the art [Moudgill1993, Sima2000]. The use of VRNs also means that dependency tracking is separated from physical value storage. VRNs are used to track dependencies while a separate PRF 10 contains the values. As such, PRF 10 can be sized according to the desired capacity of the machine, independent of the size of the architected register file.

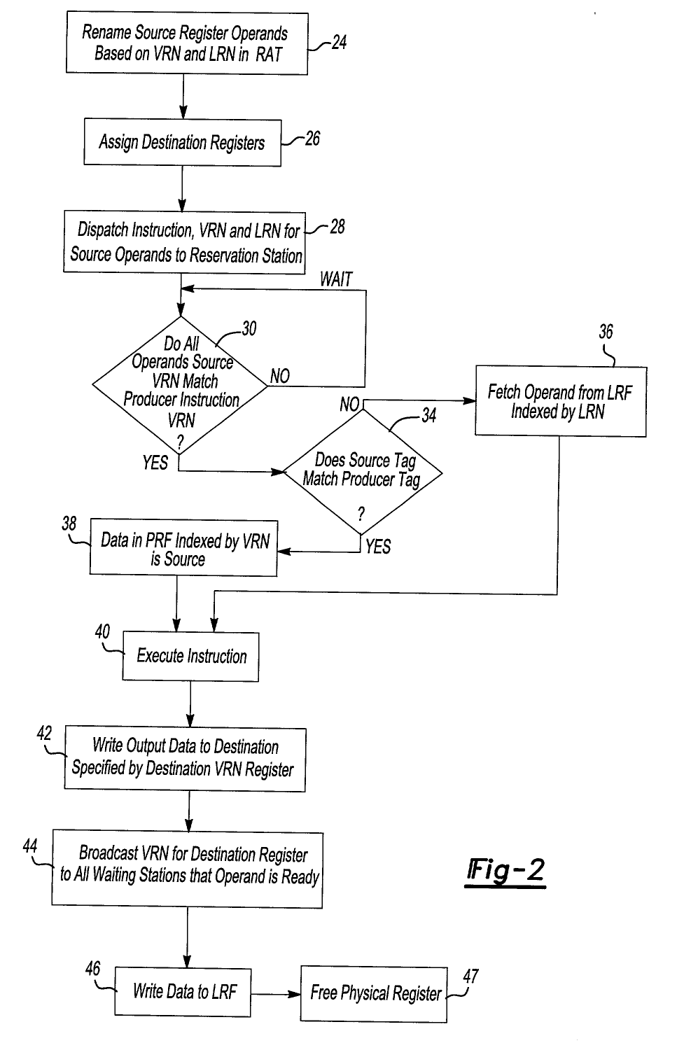

OPERATION. Referring now to FIGS. 2, 3 and 4, the operation of the present invention is described. For this explanation, it is assumed that NLR is 256 and that an 8-bit address is required to specify a logical register, NPR is 64 and a 6-bit index is required to specify a physical register, NVR is 512 and a 9-bit address is required to specify a virtual register number VRN. With respect to the 9-bit VRN, the low 6 bits index into the 64 physical registers of PRF 10, while the remaining 3 bits are used as a check tag, as described below. It is understood that other configurations can be used instead of the specific numbers as depicted above, provided that NVR>NPR+NLR.

In FIG. 4, a virtual register free list (VRFL) 43 contains numbers of all virtual registers that are currently available for use. Also shown is a physical register free vector (PRFV) 41 where each entry contains a bit that represents whether the associated physical register is free to be allocated. A register alias table (RAT) 48 maps logical register numbers (LRNs) to their corresponding virtual register numbers (VRNs).

A set of reservation stations 50 is provided. For each source operand, each reservation station contains a destination virtual register number VRN; a ready bit, a source virtual register number VRN, and a logical register number LRN.

Referring now to FIGS. 2 and 4, a flow diagram and schematic diagram are provided that describes instruction execution according to the present invention. In step 24 of FIG. 2, when an instruction is to be dispatched, the source register operands are renamed based on the contents of the RAT 48. This is accomplished by using each source register LRN to index into the RAT. At each location so accessed in the RAT, a VRN resides. This is the VRN that currently is keeping track of dependency information for that source operand. The VRN listed in RAT 48 for each operand is carried with the instruction into the reservation station 50 (branch 130 in FIG. 4). No values are read from any register file at this time.

In step 26, destination registers are assigned. Here, each destination register in the instruction is assigned a virtual register number VRN from the virtual number free list VNFL 49. The physical register free vector 41 is also queried to ensure an associated physical register is available. No virtual register number VRN whose (six) physical index bits are currently in use can be chosen for allocation. This additional constraint is necessary to ensure that no two instructions share a physical index and is a necessary side effect of the direct indexing that is used to index the physical register file PRF 10 (described later). Once a physical register number PRN meeting this constraint is chosen, its free bit in the physical register free vector PRFV is cleared to indicate that this physical register has been “pre-allocated.” A register that is pre-allocated is marked as being in use as a destination register. The present invention allows the value currently in that physical register to still be used by consumer instructions until the value is over-written with the new value for that physical register.

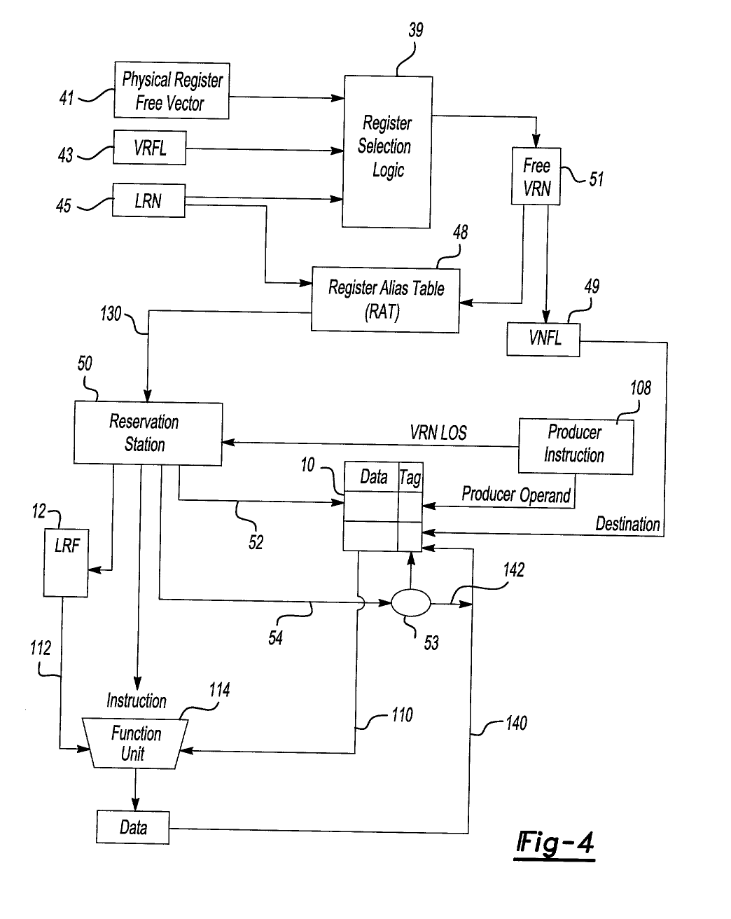

The operation of step 26 is described in greater detail with reference to the flow chart in FIG. 3. To select an appropriate destination register, the processor uses two bookkeeping structures. As the physical register free vector 41 is knowledgeable of all the free physical storage locations in the system, it is queried in step 26A to find a free physical register. Similarly, the virtual register free list VRFL 43 contains a listing of free VRNs, and is queried to find a free VRN in step 26B. An autonomous register selection circuit inside the register selection logic box 39 examines this information, and determines which virtual-physical pairs are available for allocation in step 26C. The register selection circuit then puts the matched pair onto a third list of free virtual-physical pairs VPPFL 49 in step 26D. The processor can then pull from this list to rename the destination of an incoming instruction. Essentially, the circuit is looking for a virtual register whose low six index bits describes a free physical register.

In the example system, there are 64 physical registers and 512 virtual tags, so that for any physical register there are 8 possible virtual register numbers that can meet this criterion (9 bits−6 bits=3 bits; 23=8). The register selection circuit within the register selection logic block 39 tries to find pairings where both are free. The register selection circuit has flexibility to choose the registers according to any policy that it likes and can utilize different renaming policies offline. If there is no virtual register that qualifies for renaming, the front-end of the processor stalls until one becomes available.

Referring back to FIG. 2, after the source registers have been renamed and the destination registers assigned, the newly renamed instruction is dispatched to the reservation station 50 in step 28. The instruction, in step 30, waits there until its operands become ready. Readiness is determined in when a producer instruction 108 (see FIG. 4) completes and broadcasts its VRN 105 to the reservation stations. Each station compares its unready source VRN with VRN 105 broadcasted. If there is a match, the source VRN is marked ready. When all the instruction's operands become ready, the instruction is scheduled (selected) for execution. The low 6 bits of the instructions operand source VRN are used to directly index into the 64-entry PRF 10 (branch 52 of FIG. 3). This simple indexing scheme constrains the initial selection of the VRN (in the renaming pipeline stage) but greatly simplifies the register access at this point. No associative search or table lookup is necessary.

The upper 3 bits of the source VRN are used as a check tag whose function is to verify that the value currently in the physical register comes from the correct producer 108. This is performed in step 34 in FIG. 2 and Block 53 of FIG. 3. If the PRF 10 entry has a matching 3-bit check tag, then the value in the physical register is taken as the source operand in step 38. If the tag does not match, this means that the value no longer resides in the PRF 10 (like a cache miss) and must be fetched from the LRF 12 in step 36. This means that it was committed to architected state some time ago and was evicted from the PRF 10 set by some other instruction with the same low 6 bits in its virtual number. Where the value is not available from PRF 10, a penalty is incurred by requiring the backing store (LRF 12) to be accessed. The present invention does not allocate back into the physical register file upon a miss because the value that would be allocated no longer has a VRN (it was committed). When the instruction issues to a function unit 114 (see FIG. 4) in step 40, it retrieves the necessary source operands from LRF 12 (branch 112 in FIG. 4) and PRF 10 (branch 110). This, of course, depends on the outcome of block 34 that determines whether the register value needs to be retrieved from the IRF 12 or the PRF 10. LRF 12 access can be started in parallel with PRF 10 access if there are enough ports on LRF 12 to support this. This approach would require as many ports on LRF 12 as on PRF 10. Alternatively, LRF 12 can be accessed the cycle after it is determined that PRF 10 does not contain the value. This latter approach is preferred in the present invention in order to maintain fast execution in the common case when all the source operands of an instruction are found in the PRF.

Since multiple consumers can access each physical register in PRF 10 in a single cycle, multiple ports are required on PRF 10. In the case of multiple misses to the same LRN, special scheduling logic, such as exists on other processors (as is known in the art) is preferably used in the present invention to handle the timing when a cache miss occurs.

Immediately upon completion of execution of the instruction by the function unit 114 in step 40, the speculative data is written to the PRF 10 in step 42 (branch 140 in FIG. 4). It is written to the index specified by the destination virtual register number VRN. The check tag at that location in the PRF 10 is also updated with the 3 bit check tag from the current instruction's VRN (branch 142). This completes the allocation of the physical register for the current instruction. Any previous value in this register is overwritten and its value must be accessed from the LRF 12. A write to the PRF 10 always write-allocates its result this way and never misses the cache because it is a first-time write of a speculative value. It cannot be written to the LRF 12 until it is proven to be on the correct execution path, with no exceptional conditions otherwise barring it from completion.

In step 44, the instruction, now viewed as a producer instruction 108, broadcasts its VRN to each reservation station 50 to indicate that the value is ready to allow other instructions to be executed. The physical register file is updated and the fact that the result is ready is forwarded immediately to any consumers that require it. The result of the instruction is finally carried down the pipeline into a reorder buffer. If this were not done, then PRF 10 would need more read ports in order to read out values when they are committed to the LRF 12. When the instruction is able to commit, its value is written to the LRF 12 (architected state) and the instruction is officially committed in step 46. In step 150, the associated physical register of PRF 10 is freed. Resetting the bit in the physical register free vector accomplishes this and releases the physical register for future use. The data, however, remains in PRF 10 until it is overwritten. As such, later consumers can use this data from PRF 10 until it is allocated to another instruction. This physical register release mechanism thus pre-allocates a physical register when the instruction enters the pipeline, finally allocates it when the instruction completes its execution, and releases it immediately when the instruction commits. The physical register is free to be pre-allocated again as soon as needed by a second instruction, but the old value may remain in the physical register until the final allocation happens for the second instruction.

The virtual register number VRN for an associated logical register can be released under conditions of “free-at-remap-commit.” Here, the virtual register number for a logical register can be released when another virtual register number VRN is assigned to the logical register, and the instruction that writes the second VRN commits. As the virtual register numbers have no associated storage, a large number can be implemented without slowing down the processor. For example, the designer can implement as many as are needed to avoid stalling instruction issue due to lack of free VRNs. Additionally, excess bits in the VRNs can be specified if other information is needed (for example, an expanded check-tag section or to hold other important information including producer and consumer relationships or branch information). Accordingly, no early release mechanism for VRNs is required in the present invention.

Because the LRF 12 maintains the precise architected register state between each instruction in the program, recovery from exceptions and branch mispredictions is easily handled. Instructions which are younger than the excepting instruction are cleared from the machine. Older instructions are retained. The logical to virtual mappings are maintained as in the conventional art. Entries from the physical register file do not need to be destroyed. Specifically, any consumers that may consume bogus or incorrect values have been cleared from the machine. Also, the bogus values are overwritten at some future point. As such, useful values are advantageously retained in the physical register file (even committed values); i.e. the PRF (cache) is not cleared even for a mis-predicted branch. Otherwise, the LRF would need to supply all values initially after a branch mis-prediction. This operation would be slow as the LRF 12 may have few ports.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A computing device comprising:
a logical register file having a specified logical register that stores an architected operand;
a physical register file having a specified physical register that stores a speculative operand;
a plurality of virtual register numbers, a number of the plurality of virtual register numbers being greater than a total number of logical registers in the logical register file plus a number of physical registers in the physical register file; and
a processor adapted to process at least one instruction of the instruction set based on the architected operand or the speculative operand;
wherein the specified physical register is mapped to the specified logical register through a specified one of the plurality of virtual register numbers, the specified physical register being direct mapped to the specified logical register.

2. The computing device according to claim 1, wherein the specified physical register is not mapped to the specified logical register through an associative search.

3. The computing device according to claim 1, wherein the specified virtual register number is associated with a source operand for the instruction.

4. The computing device according to claim 3, wherein the specified virtual register number includes:
a set of physical index bits that directly index to the specified physical register;
a set of implementation-defined information bits;
a set of sequencing bits that includes the physical index bits and the implementation-defined information bits for guaranteeing correct instruction sequencing and dependency tracking; and
a set of check tag bits for verifying a location of a value in the physical register file or the logical register file.

5. The computing device according to claim 4, further comprising a waiting station that holds the instruction and the specified virtual register number, the waiting station adapted to recognize operand readiness for the instruction when the third set of sequencing bits matches a producer set of bits broadcasted by a producer instruction.

6. The computing device according to claim 5, wherein the processor is adapted to execute the instruction based on the speculative operand when the check tag bits matches a second set of check tag bits, the second set of check tag bits provided to the specified physical register by the producer instruction.

7. The computing device according to claim 5, wherein:
the check tag bits are upper bits of the specified virtual register number; and
the physical index bits are lower bits of the specified virtual register number.

8. The computing device according to claim 6, wherein the processor is adapted to execute the instruction based on the architected operand when the check tag bits does not match the second set of check tag bits in the specified physical register.

9. The computing device according to claim 1, further comprising a register alias table that stores a plurality of logical register numbers indicating locations of logical registers in the logical register file, each of the logical register numbers being associated with a virtual register number in the plurality of virtual register numbers.

10. The computing device according to claim 1, further comprising:
register selection logic;
a physical register free vector containing a listing of free physical registers in the plurality of physical registers;
a virtual register free list that contains a listing of free virtual register numbers in the plurality of virtual register numbers;
wherein the register selection logic is adapted to poll the physical register free vector to find free physical registers and associate any of the free physical registers with any of the free virtual numbers to create virtual-physical pairs.

11. The computing device according to claim 10, further comprising a virtual-physical pair free list that stores the virtual-physical pairs.

12. The computing device according to claim 10, further comprising:
a second specified physical register; and
a second specified virtual register number;
wherein the second specified virtual register number maps to the second specified physical register file; and
wherein the processor is adapted to store output data in the second specified physical register file.

13. The computing device according to claim 1, wherein at least one of the plurality of virtual register numbers contains excess bits that specify additional information.

14. The computing device according to claim 13, wherein the excess bits contains information relating to at least producer and consumer relationships or branch information.

15. A method for executing an instruction by a processor comprising the steps of:
providing a logical register file having at least one specified logical register for storing an architected operand;
providing a physical register file having at least one specified physical register for storing a speculative operand;
providing a plurality of virtual register numbers, one of the plurality of virtual register numbers being a specified virtual register number, a number of the plurality of virtual register numbers being greater than the number of logical registers in the logical register file plus a number of physical registers in the physical register file, the specified physical register is directly indexed to the specified logical register;
providing a register alias table that associates a logical register number for the specified logical register with the specified virtual register number;
renaming the architected operand based on the specified virtual register number;
comparing a set of bits of the specified virtual register number with a virtual register number broadcasted from a producer instruction in order to determine whether an operand produced by the producer instruction is an operand needed to execute the instruction;
comparing check tag bits of the specified virtual register number with a speculative operand check tag to determine whether the producer instruction is a correct producer instruction or an incorrect producer instruction;
executing the instruction based on the speculative operand if the comparing check tag bits step indicates that the producer instruction is the correct producer instruction;
executing the instruction based on the architected operand if the comparing check tag bits indicates that the producer instruction is the incorrect producer instruction; and
storing data generated by executing the instruction at a destination physical register.

16. The method for executing an instruction according to claim 15, further comprising the step of selecting the destination physical register from a virtual number free list before the storing data step.

17. The method for executing an instruction according to claim 16, further comprising the steps of:
querying the physical register free vector to identify free physical registers in the physical register file, each physical register of the physical register file having a respective entry of said physical register free vector that indicates whether the register is free or busy;
searching a virtual number free list to identify free virtual numbers of the plurality of virtual register numbers;
associating at least one free physical register with a free virtual number;
listing the free physical register and the free virtual number on a virtual-physical pair free list, wherein the destination physical register is the free physical register.

18. The method for executing an instruction according to claim 15, further comprising the step of:
dispatching the instruction and the specified virtual register number to a waiting station after the renaming step.

19. The method for executing an instruction according to claim 18, wherein the step of executing the instruction based on the speculative operand further comprises:
directly indexing the specified physical register with the specified virtual number;
retrieving the speculative operand from the specified physical register; and
executing the instruction based on the speculative operand retrieved from the specified physical register.

20. The method for executing an instruction according to claim 18, further comprising the steps of:
dispatching a logical register number of the specified logical register to the waiting station with the instruction;
pulling the architected operand from the specified logical register by indexing the logical register number to the specified logical register for performing the step of executing the instruction based on the architected operand.

21. The method for executing an instruction according to claim 15, further comprising the step of maintaining the data in the destination physical register until the data is overwritten by a producer instruction, the data being overwritten by the producer instruction after the data is committed to an architected state.

22. A computing device comprising:
a logical register file means for storing an architected state of an architected operand;
a physical register file means for storing a speculative state of a speculative operand;
a virtual register number means for mapping the logical register means to the physical register means; and
a processor means for performing out-of-order processing of an instruction set based on the architected operand or the speculative operand.
